(19) United States
(12) Patent Application Publication
(10) Pub. No.: US 2014/0372139 A1
(43) Pub. Date: Dec. 18, 2014

(54) SYSTEM FOR MONITORING AND TRACKING PATIENT OUTCOMES AFTER SURGICAL IMPLANTATION OF AN INTRACORNEAL LENS

(71) Applicant: PresbiBio, LLC, Irvine, CA (US)

(72) Inventors: Vanessa Tasso, Santa Ana, CA (US); Vladimir Feingold, Irvine, CA (US)

(21) Appl. No.: 14/304,683

(22) Filed: Jun. 13, 2014

Related U.S. Application Data
(60) Provisional application No. 61/835,091, filed on Jun. 14, 2013.

(51) Int. Cl. G06Q 30/06; G06Q 50/22

(52) U.S. Cl. CPC G06Q 30/0621; G06Q 50/22; G06Q 30/0633
USPC 705/2

(57) ABSTRACT

A method and system are described for patient data and ordering of intraocular lens implants. One embodiment is implemented by receiving refraction data about an eye of a patient into which an intracorneal lens is to be implanted. This refraction data is received after being input through a first tab of a user interface that is displayed by a server or a client computer. The server or client computer then computes and displays a recommended specification for the intracorneal lens based on the refraction data. The server then receives an order for a lens based on the recommended specification. Other embodiments are described and claimed.

### CROSS-REFERENCE TO RELATED APPLICATION

The present application claims priority from U.S. Provisional Application No. 61/835,091, filed on Jun. 14, 2013.

### FIELD

The present invention relates to computer software for patient data. More particularly, the present invention relates to clinical evaluation server software for patient data and ordering of intraocular lens implants.

### BACKGROUND

The human eye, in simple terms, functions to provide vision by transmitting and refracting light through a clear outer portion called the cornea and focusing the image by way of the lens onto the retina at the back of the eye. The quality of the focused image depends on many factors including the size, shape, and length of the eye, and the shape and transparency of the cornea and lens.

Trauma, age, or disease can cause a reduction in visual acuity, as can diseases such as presbyopia. One treatment for this and similar conditions is surgical removal of the lens and implantation of an artificial lens, often termed an intraocular lens (IOL).

Typically, intraocular lens surgery and design involves large amounts of patient data. Standard storage techniques can be insecure, can disperse or lose data, and can be inefficient. Further, problems with the surgery can present themselves months after the surgery is complete, but asking doctors to perform regular checkups can be time-consuming, difficult to organize, and inefficient.

### BRIEF DESCRIPTION OF THE DRAWINGS

FIG. 1 is a diagram of an eye having an intracorneal lens implanted therein.

FIG. 2 is a block diagram illustrating one embodiment of a clinical evaluation software for transmitting data between client computing devices and a server computing system, and to monitor and capture patient data and postoperative outcomes.

FIG. 3 is a block diagram illustrating the components included in a clinical evaluation server computing system according to one embodiment of the invention.

FIG. 4A is a block diagram illustrating an example login screen for an application executed by a clinical evaluation server computing system.

FIG. 4B is a block diagram illustrating an example patient data input screen for an application executed by a clinical evaluation server computing system.

FIG. 4C is a block diagram illustrating a lens ordering screen for an application executed by a clinical evaluation server computing system.

FIG. 4D is a block diagram illustrating a post-operation monitoring screen for an application executed by a clinical evaluation server computing system.

FIG. 5 is a flow diagram illustrating a method for monitoring and collecting postoperative outcomes data associated with a surgically implanted intracorneal lens, according to one embodiment of the invention.

FIG. 6 is a flow diagram illustrating a method for customizing an intracorneal lens that is to be surgically implanted according to one embodiment of the invention.

### DETAILED DESCRIPTION

Several embodiments of the invention with reference to the appended drawings are now explained. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

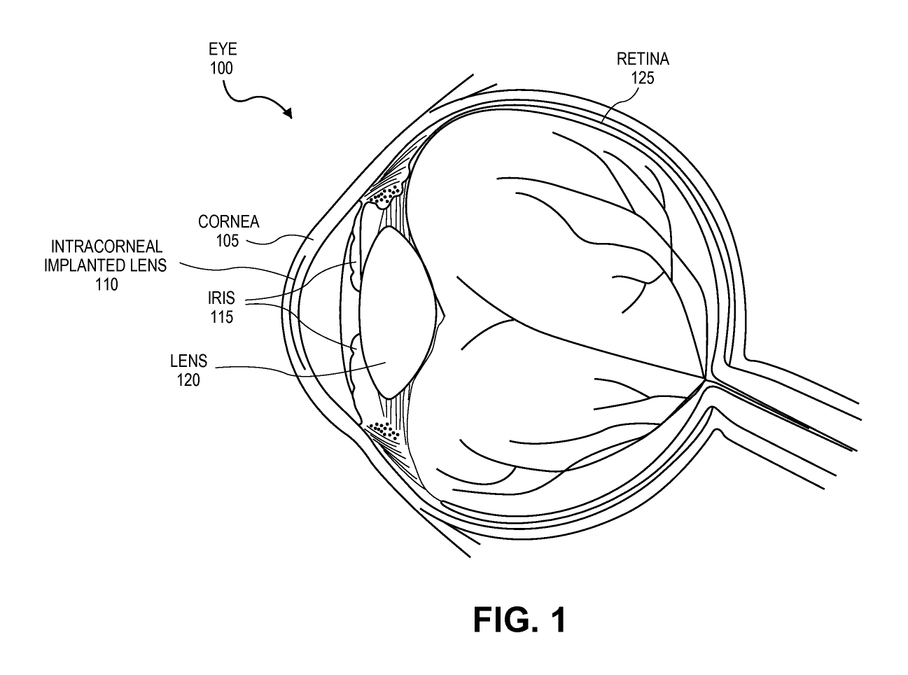

Beginning first with FIG. 1, a diagram is shown illustrating an eye having a lens intracorneal lens implanted therein. For an individual having vision problems, a lens 110 may be positioned in the cornea of an individual's eye 100 to improve his or her visual acuity. The lens 110 may be designed to compensate for one or more vision problems, such as presbyopia.

The procedure of intracorneal positioning of a lens in an individual does not remove tissue (e.g., corneal tissue), but rather inserts the lens 110 within the cornea of an individual's eye 100. In the embodiment illustrated in FIG. 1, the lens 110 is implanted within the cornea 105 of the eye 100. Accordingly, light reaching the lens 120 of the eye 100 will generally pass through the lens 110, and the lens 110 may improve the visual acuity of the individual.

To ensure that the lens is satisfactory for the individual, a power commensurate with the individual's vision problem must be selected for the lens 110. The selection must be accurate in order to avoid, for example, the need to remove and replace the lens from the patient's eye. In one embodiment, the required lens power is calculated by measuring the manifest refraction spherical equivalent (MRSE) for the eye to be treated 100, which is then adjusted by 0.25 diopters (D) (e.g., by increasing or decreasing the diopters from the MRSE). The 0.25D adjustment to the near MRSE is required in order to accommodate for standard test distance measurement practices. The individual may need to be observed after the intracorneal implantation of the lens 110 to confirm that the individual is satisfactorily adapting to the lens 110 within the eye 100.

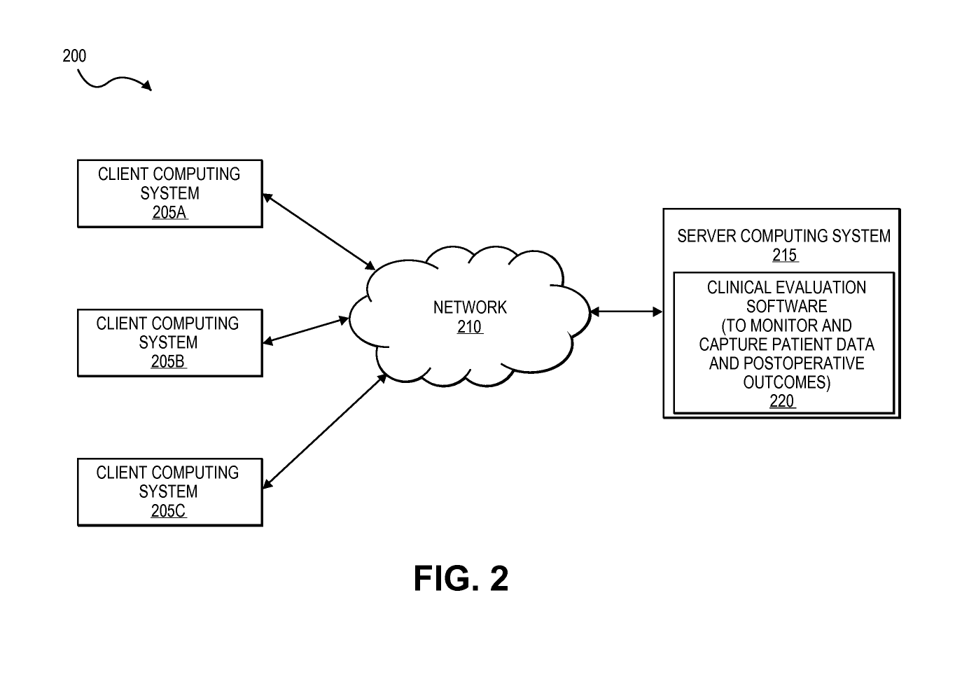

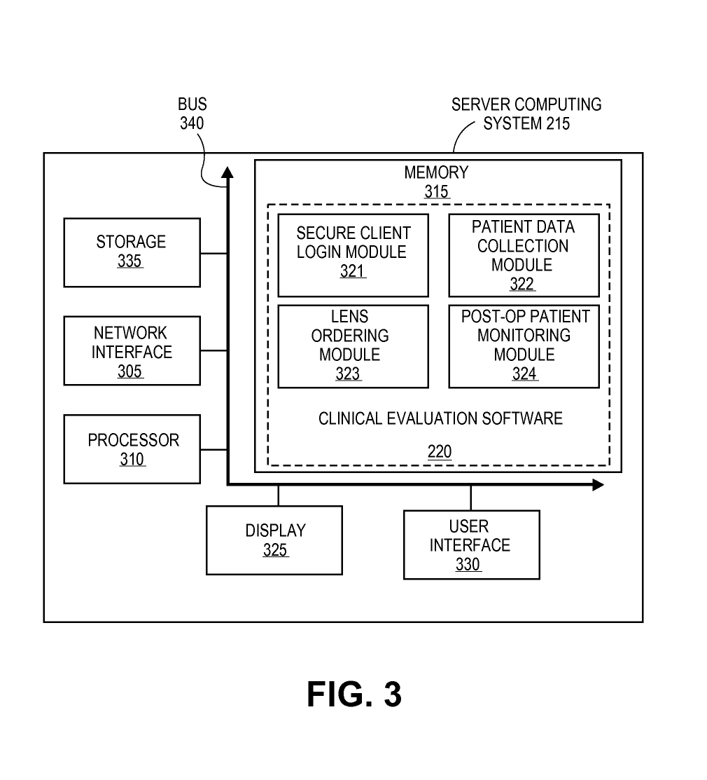

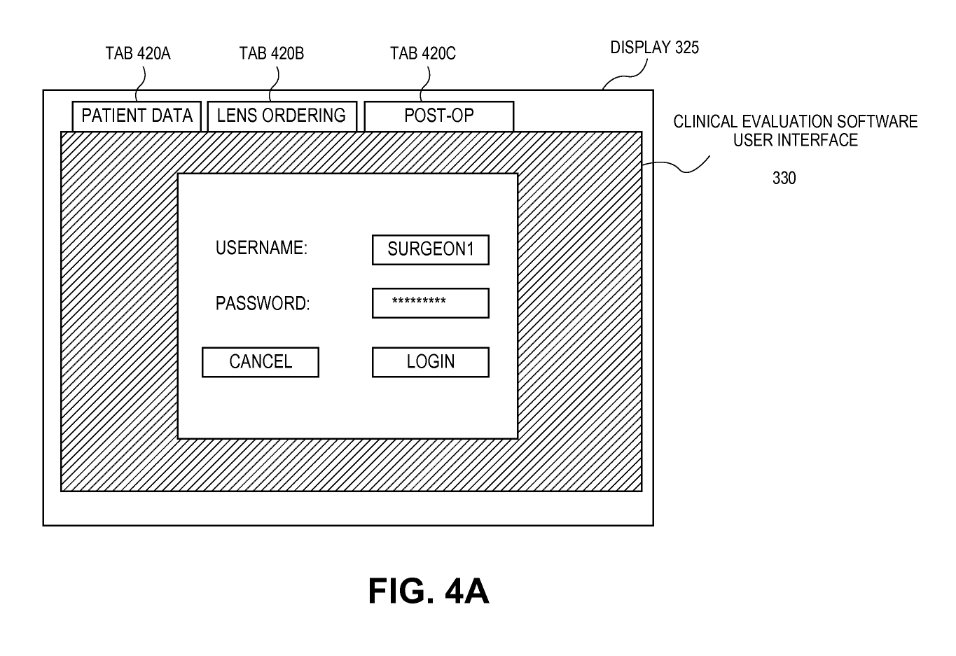

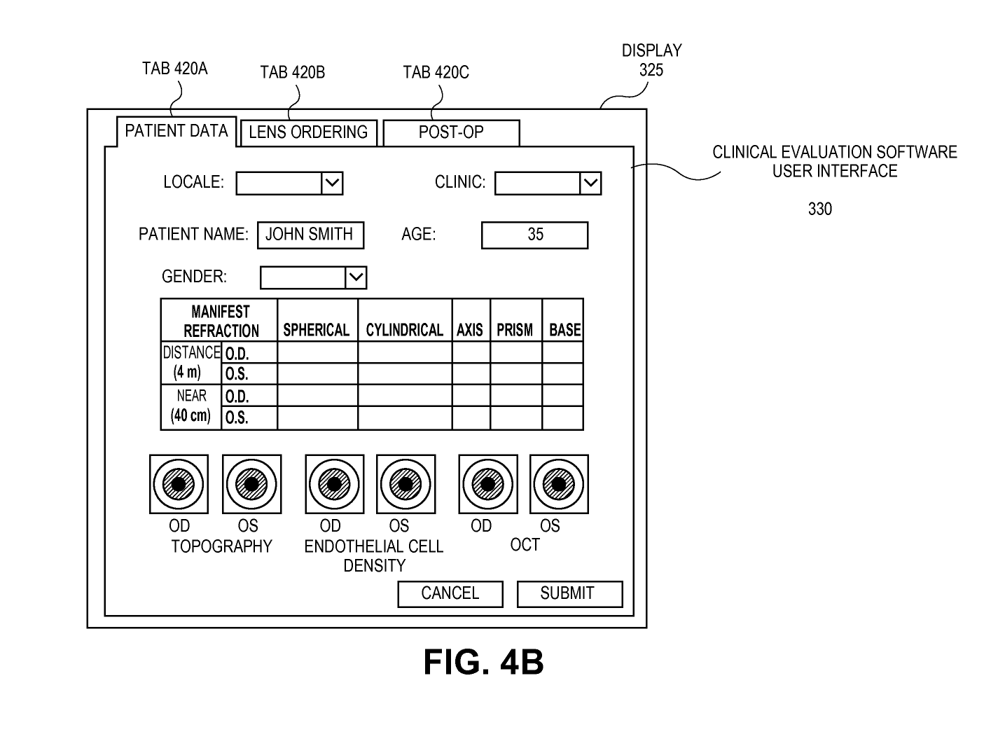

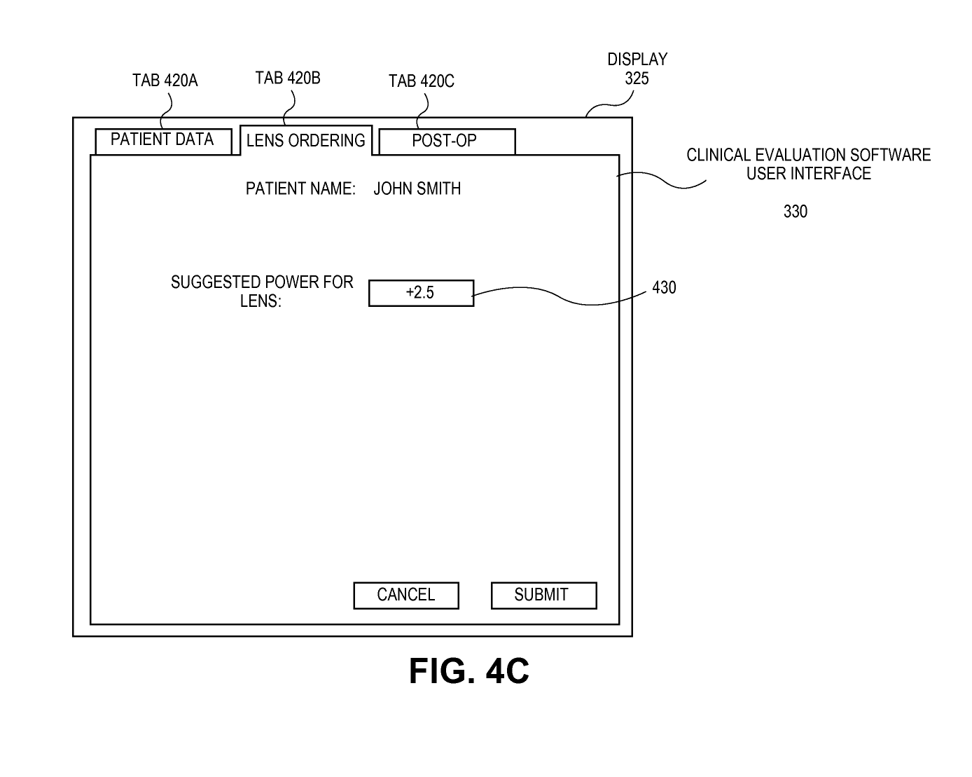

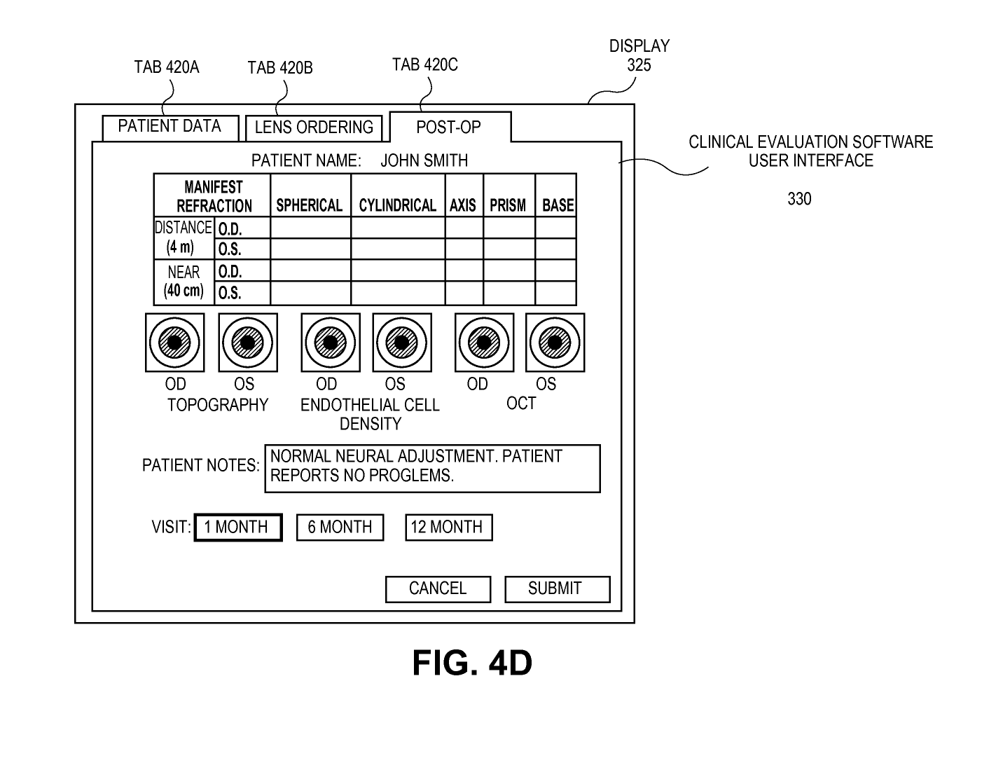

Turning to FIG. 2, a block diagram illustrates a server computing system 215, including an embodiment of a clinical evaluation software 220 to monitor and capture patient data and postoperative outcomes, to transmit data between a number of client computing systems 205A-C. While in the illustration only three client computers are shown, it is to be appreciated that there may be potentially a large number of such client computers depending upon for example the number of users. Also, while the clinical evaluation software 220 is illustrated as being executed by the server computing system 215, in some embodiments a client computer (e.g., 205A, 205B, or 205C) may execute some part of the clinical evaluation software 220. For example, in some embodiments, the client computer 205 may compute a recommended specification for the lens (as described in reference to FIG. 4C), or the user interface 330 (described in FIG. 3 and FIG. 4A-4D) may be displayed by the client computer 205 and may send patient data or lens orders to the server computing system 215 based on user interface inputs collected by the client computer 205.

Both the server computing system 215 and a client computing system 205 may represent a desktop, workstation, server, laptop, tablet, smartphone, or another type of computer. Examples of suitable machines include, but are not limited to, desktops, laptops, tablets, smartphones, network elements, storage appliances, equipment of remote archive repositories, and other electronic devices, equipment, elements, or systems having one or more microprocessors. Such electronic devices typically include one or more processors coupled with one or more other components, such as one or more storage devices (non-transitory machine-readable storage media), user input/output devices (e.g., a keyboard, a touch screen, and/or a display), and/or network connections. The coupling of the processors and other components is typically through one or more buses/interconnects and bridges (also termed bus controllers). Thus, the storage device of a given electronic device may store code and/or data for execution on the one or more processors of that electronic device. The server computing system 215 may, in some embodiments, be a back-end computing system, while the client computer (e.g., 205A, 205B, or 205C) provides the front-end (i.e., user interface 330).

The computers 205A-C are communicatively coupled with the server computing system 215 via the network 210. The network 210 may represent one or more public, private, wired, wireless, hybrid, or other types of networks, or a combination of different types of networks. The network 210 can be implemented as a local area network (LAN), a wide area network (WAN) such as the Internet, a corporate intranet, telecommunications (cell phone) platforms, a metropolitan area network (MAN), a storage area network (SAN), a Fibre Channel (FC) network, a bus, or a combination thereof.

In the embodiment shown at FIG. 2, the server computing system 215 includes a clinical evaluation software 220 to monitor and capture patient data and postoperative outcomes. The clinical evaluation software 220 is configured to receive data from a client computing system 205. In one embodiment, the clinical evaluation software 220 is configured to receive data about a patient. The clinical evaluation software 220 may then compute one or more parameters (e.g., a power) for a lens that is to be implanted into the cornea of the patient. Subsequently, the computed lens parameter(s) are presented to a user at the client computing system 205. The user may then input an order through the client computing system 205 that is received and processed by the clinical evaluation software 220. In a separate process, the lens order is then fulfilled and delivered to the user so that it may be implanted in a patient.

In a further embodiment, the clinical evaluation software 220 may receive additional data about the patient, following the intracorneal surgical implantation of the lens. This post-operational patient data may be used to generate one or more reports that indicate, for example, that the clinical evaluation software 220 is correctly computing a parameter for a lens, that the patient is satisfactorily neurally adapting to the lens, and similar data about the patient.

The clinical evaluation software 220 may be presented to a client computing system 205 through any well-known approach. For example, the client computing system 205 may access the clinical evaluation software 220, while the latter is being hosted at the server computing system 215, using a uniform resource identifier (e.g., a web address). Correspondingly, the clinical evaluation software 220 may be implemented using a server-side web application framework (e.g., Microsoft ASP.NET). In one embodiment, the clinical evaluation software 220 is implemented as Software as a Service (SAAS) so that the functionality of the clinical evaluation software 220 is remotely provided by the server computing system 215 to a client computing system 205 over the network 210.

In another embodiment, a client-side software application (not shown) at a client computing system (e.g., 205A, 205B, or 205C) provides a user interface (not shown) and/or additional functionality, such as the ability to enter patient data remotely and transmit the patient data to the clinical evaluation software 220 running on the server computing system 215. The patient data may be, for example, images of one or both eyes of a patient that are related to the eye topography, endothelial cell density, optical coherence tomography (OCT), a slit lamp assessment of the patient's eye, a uncorrected or corrected visual acuity reading of the patient's eye at a distance (e.g. about 4 m) or nearby (e.g. about 40 cm) or at the patient's preferred distance, relevant scan images of a patient's eye, or other similar images. The patient data may also be an indication of how the patient is adjusting or neurally adapting to the lens. In such embodiments, the clinical evaluation software 220 on the server computing system 215 may be configured as a repository to store and/or organize the patient data, while core functionality (e.g., user interface, data manipulation, computations, etc.) is performed by the client-side software application (not shown) at the client computing system (e.g., 205A, 205B, or 205C). In some embodiments, the client-side software application (not shown) may also act as a repository to store and/or organize the patient data temporarily or as a backup of the patient data stored using the clinical evaluation software 220 on the server computing system 215. In some embodiments, the client computing system 205 may be a smartphone or tablet device, and the client-side software application (not shown) may be a smartphone or tablet application.

Now with reference to FIG. 3, this is a block diagram that illustrates the server computing system 215. The server computing system 215 can be a desktop, workstation, server, or other computer, or other type of data processing system and can be included as part of the server computing system 215 of FIG. 2. The server computing system 215 includes multiple components including, but not limited to, a network interface 305, a processor 310, memory 315, a display 325, a user interface 330, and storage 335. The illustrated components are communicatively coupled via a bus 340. The bus 340 can be any subsystem adapted to transfer data within the system 215. The bus 340 can be a plurality of computer buses and include additional circuitry to transfer data. In some embodiments, the server computing system 215 may forego one or more of these components; for instance, the server computing system 215 may lack a display 325 if the user interface 330 is displayed by the client computer (e.g., 205A, 205B, or 205C in FIG. 2). In some embodiments, the server computing system 215 may include additional components not discussed herein, such as computer input devices (e.g., a keyboard, a mouse, a touchscreen).

The network interface 305 can accept data across a network (not shown) from a client computing system (not shown) to be processed and/or stored in the system 215. The network interface 305 can be implemented in hardware, software or a combination of the two and can include, for example, components such as a network card, network access controller, or a host bus adapter. The network interface 305 is communicatively coupled with a processor 310. The processor 310 executes instructions for the server computing system 215. In one embodiment, some or all of the instructions for the network interface 305 are executed by the processor 310.

Both storage 335 and memory 315 may include instructions and data to be executed by the processor 310. Storage 335 can be implemented locally via the bus 340 (as shown) or remotely (e.g., cloud storage) via a network, such as a cellular data, Wi-Fi or WiMax network (not shown). In some embodiments, storage 335 includes non-volatile memory, such as read-only memory (ROM), flash memory, and the like. Furthermore, storage 335 can include removable storage devices, such as secure digital (SD) cards. Storage 335 can be, for example, conventional magnetic disks, optical disks such as CD-ROM or DVD based storage, magnetic tape storage, magneto-optical (MO) storage media, solid state disks, flash memory based devices, or any other type of storage devices suitable for storing data.

Memory 315 may offer both short-term and long-term storage and may in fact be divided into several units. Memory 315 may include volatile data storage, such as static random access memory (SRAM) and/or dynamic random access memory (DRAM). Memory 315 may provide storage of computer readable instructions, data structures, application modules, and other data for the server computing system 215. Such data can be loaded from storage 335. Memory 315 may also include cache memory, such as a cache located at the processor 310.

In the illustrated embodiment, memory 315 includes or has stored therein the clinical evaluation software 220. The clinical evaluation software 220 may be included as part of the clinical evaluation software 220 of FIG. 2 to monitor and capture patient data and postoperative outcomes. Still with reference to FIG. 3, the clinical evaluation software 220 may include the following software modules containing instructions to be executed by the processor 310: (1) a secure client login module 321; (2) a patient data collection module 322; (3) a lens ordering module 323; and (4) a post-operation patient monitoring module 324. In some embodiments, clinical evaluation software 220 may also include other software modules not described herein.

The secure client login module 321 is configured to allow a remote system (e.g., a client computing system) to access services provided by or hosted at the server computing system 215 on which the clinical evaluation service software 220 may be running The network interface 305 may receive login credentials (e.g., a username and/or password) from a client computing system (e.g., 205A, 205B, or 205C of FIG. 2) and subsequently provide the login credentials to the secure client login module 316. The secure client login module 316 may then validate the credentials to allow a user at the client computing system 205 to access the functionality of the clinical evaluation software 220 through the network 210. Thus, data, such as patient data relating to a patient's eye, or a patient's medical or vision insurance information, may be confidentially maintained at the server computing system 215.

In some embodiments, this confidentiality of patient eye data and patient medical or vision insurance data allows the clinical evaluation software 220 to comply the Health Insurance Portability and Accountability Act.

Once valid credentials have been received from a client computing system, the client computing system is able to access the remaining modules 322-324 of the clinical evaluation software 220. Initially, a client computing system may be directed to the patient data collection module 322. At this module 322, a user (e.g., a nurse or surgeon) of the client computing system is able to input data related to a patient that is to receive a lens implant. The inputted data is then received at the patient data collection module 322 through the network interface 205. Such data related to the patient may include, but is not limited to, a geographical region (e.g., a country or continent) in which the patient, and/or the user who may be a health care provider of the patient) reside, a clinic at which the patient is located, a name of the patient, an age of the patient, a gender of the patient, and other similar information.

The patient data collection module 322 is further configured to receive ocular data about a patient. In one embodiment, the patient data collection module 322 is configured to receive manifest refraction data about one or both eyes of a patient. For example, the patient data collection module 322 may receive data related to a spherical and/or cylindrical correction for the patient's left eye (O.S.) and/or the patient's right eye (O.D.), as well as the axis, prism, and/or base values. In one embodiment, the patient data collection module 322 may receive images of one or both eyes of a patient that are related to the eye topography, endothelial cell density, optical coherence tomography (OCT), a slit lamp assessment of the patient's eye, a uncorrected or corrected visual acuity reading of the patient's eye at a distance (e.g. about 4 m) or nearby (e.g. about 40 cm) or at the patient's preferred distance, relevant scan images of a patient's eye, or other similar images.

Additionally, the patient data collection module 322 may implement one or more checks for patient safety. In one embodiment, the patient data collection module 322 may evaluate data received from the user related to the patient, to “check” that the patient is an acceptable candidate for lens implantation. Additional patient data received from the user related to the patient may include a slit lamp assessment of the patient's eye, manifest refraction of the patient's eye, and visual acuity of the patient's eye for distance (e.g., at about 4 m) and near (e.g., at about 40 cm), uncorrected and corrected, in addition to uncorrected near visual acuity at the distance preferred by the patient. If the patient is not an acceptable candidate for lens implantation, an alert may be presented to the user at the client computing system informing the user of such.

Once data for a patient has been received at the patient data collection module 322, one or more lenses may be ordered for the patient through the lens ordering module 323. In one embodiment, the lens ordering module 323 computes one or more recommended parameters for a lens that is to be ordered—e.g., the lens ordering module 323 may compute a recommended power for a lens. A user (e.g., a nurse or surgeon) may then input an order for a lens at a client computing system, where the order is then received at the lens ordering module 323 through the network interface 305. Subsequently, the ordered lens is received by the user and is intraocularly implanted in the patient.

After a lens is implanted into a patient, the patient may need to be monitored by a user (e.g., a nurse or surgeon) of the client computing system that is communicatively coupled with the server computing system 215. The clinical evaluation software 220 includes a post-operation patient monitoring module 324. The post-operation patient monitoring module 324 is configured to maintain data related to the patient's acclimation to the lens implantation. To that end, the post-operation patient monitoring module 324 may receive an indication of how the patient is neurally adapting to the lens. Furthermore, the post-operation patient monitoring module 324 may include measurement and image fields similar to those included in the patient data collection module 322 that indicate the improvement in the patient's visual acuity after the lens implantation. Additional post-operation patient data received from the user related to the patient may include a slit lamp assessment of the patient's eye, manifest refraction of the patient's eye, and visual acuity of the patient's eye for distance (e.g., about 4 m) and near (e.g., about 40 cm), uncorrected and corrected, in addition to uncorrected near visual acuity at the distance preferred by the patient.

In one embodiment, the post-operation patient monitoring module 324 tracks multiple sets of data for the same patient. For example, the post-operation patient monitoring module 324 may include a data set for monitoring the patient one month after the lens implantation, another data set for monitoring at six months after implantation, and another data set for monitoring at twelve months after implantation. Other time intervals for obtaining repeated monitoring data sets from the user are possible. Thus, a user (e.g., a nurse or surgeon) may track the neural adaptation of the patient to the lens to ensure that the patient's visual acuity is expectedly improving.

Turning now to FIGS. 4A-D, several screen shot diagrams illustrate an embodiment of the presentation of the clinical evaluation service (e.g., the clinical evaluation software 220 of FIG. 3) to a user at a client computing system. In some embodiments, the clinical evaluation service, which is generating these screens, may be hosted at a system that is remote from the system that is rendering or displaying the screens, such as in a Software as a Service implementation.

Beginning with FIG. 4A, a login screen for the clinical evaluation software 220 is provided at the clinical evaluation software user interface 330 (e.g., by a secure client login module) and rendered on the display 325. In the illustrated embodiment, the login screen includes user input fields, for obtaining a username and a password from the user of the clinical evaluation software 220. In combination, the username and password function as login credentials for the lens ordering and monitoring service. A user (e.g., a nurse or surgeon) may input these credentials and then select submit, and the lens ordering and monitoring service may verify these credentials so that the user may access the functionality provided by the clinical evaluation service. Other forms of credentials and verification are possible, e.g., biometric authentication. Additionally, in some embodiments, the login screen may instead be provided by the client-side software application and displayed to the user of the client computing system (e.g., 205A, 205B, or 205C of FIG. 2), after which the login data may be sent through the network 210 to the server computing system 215 and verified at the clinical evaluation software 220.

Once the credentials of the user have been validated by the software, the software allows the user to navigate through the clinical evaluation service using at least the three tabs 420B-D. At the first tab 420A, data related to a patient of the user is to be received, as shown in FIG. 4B. This tab 420A may be provided by a patient data collection module of the clinical evaluation service.

In the illustrated embodiment, the patient data tab 420A of the clinical evaluation software user interface 330 presents to the user several inputs (e.g., selectable dropdowns, textual and image input fields, etc.) for collecting data about a patient. In the illustrated embodiment, the patient data tab 420A includes textual input fields for the manifest refraction data about one or both eyes of a patient. The manifest refraction data includes input fields at distances of for example four meters (m) for distance vision and forty centimeters (cm) for near vision, for the determination of the patient's manifest refraction spherical equivalent based on spherical and cylindrical correction parameters, as well as the axis, prism, and base of the patient's left eye (O.S.) and the patient's right eye (O.D.). The patient data tab 420A further includes image input fields configured to receive images of the patient's eyes that are related to the eye topography, endothelial cell density, optical coherence tomography (OCT), a slit lamp assessment of the patient's eye, a uncorrected or corrected visual acuity reading of the patient's eye at a distance (e.g. about 4 m) or nearby (e.g. about 40 cm) or at the patient's preferred distance, relevant scan images of a patient's eye, or other similar images. Although not illustrated, other fields, such as patient medical or vision insurance data fields, are contemplated by the scope of this Detailed Description. Additionally, in some embodiments, the patient data tab 420A may instead be displayed by the client-side software application at the client computing system (e.g., 205A, 205B, or 205C of FIG. 2), after which the patient data may be sent through the network 210 to the server computing system 215 and stored at the clinical evaluation software 220.

Following the entry of patient data at tab 420A, the user may navigate to a lens ordering tab 420B, as shown in FIG. 4C, by selecting the lens ordering tab 420B in the clinical evaluation software user interface 330 or by selecting the “Submit” button input at the patient data tab 420A. At the lens ordering tab 420B, an order for a lens for the patient of the user may be ordered. This tab 420B may be provided by a lens ordering module of the clinical evaluation service.

At the lens ordering tab 420B, a suggested power for a lens for the patient is presented to the user of the lens ordering and monitoring service. This suggested power may be computed using some or all of the data inputted by the user at the patient data tab 420A. In one embodiment, the suggested power is computed using a specific formula or algorithm that considers the patient's manifest refraction spherical equivalent to adjust the diopter so that a lens ordered for the patient may compensate for visual axis and/or its location in the patient's eye (e.g., in the patient's cornea). The user may then order a lens with the suggested power for the patient by, for example, selecting the “Submit” input button presented to the user at the clinical evaluation software user interface 330. Although not illustrated, other fields are contemplated by the scope of this description—e.g., different powers may be suggested for the patient's eyes, the quantity of lenses to be ordered may be adjusted, etc. Additionally, in some embodiments, the lens ordering tab 420B may instead be displayed by the client-side software application at the client computing system (e.g., 205A, 205B, or 205C of FIG. 2), after which the lens order may be sent through the network 210 to the server computing system 215 and processed at the clinical evaluation software 220.

In one embodiment, the integrity of the suggested power for the lens 430 is maintained as the user navigates across the tabs 420A-C. Thus, the user may return to the patient data tab 420A and modify data that influences the suggested power for the lens (e.g., a field of the manifest refraction spherical equivalent) and when the user then returns to the lens ordering tab 420B, the suggested power for the lens 430 is updated to reflect the changed data from the patient data tab 420A.

In response to an order placed by the user through the lens ordering tab 420B for a lens, the ordered lens is then delivered to the user, and is implanted in the cornea of the patient. After this operation, the user may wish to enter post-operation data about the patient by selecting the post-op tab 420C in the clinical evaluation software user interface 330, as shown in FIG. 4D. This tab 420C may also be provided by the post-op patient monitoring module of the clinical evaluation service.

The post-op tab 420C is configured to maintain data related to the patient's acclimation to the lens implantation. To that end, the post-op tab 420C may include a textual input field to receive data indicating how the patient is neurally adapting to the lens. Similar to the patient data tab 420A, the post-op tab 420C of the clinical evaluation software user interface 330 presents to the user several inputs (e.g., selectable dropdowns, textual and image input fields, etc.) for collecting data about a patient. Here, the post-op tab 420C includes textual input fields for the manifest refraction data about one or both eyes of a patient. The manifest refraction data includes input fields at the same distances that were used for the refraction data that was entered into the patient data tab 420, e.g. about four meters (m) for distance vision and forty centimeters (cm) for near vision for the determination of the patient's manifest refraction spherical equivalent based on spherical and cylindrical correction parameters, as well as the axis, prism, and base of the patient's left eye (O.S.) and the patient's right eye (O.D.). The post-op tab 420C further includes image input fields configured to receive images of the patient's eyes that are related to the eye topography, endothelial cell density, optical coherence tomography (OCT), a slit lamp assessment of the patient's eye, a uncorrected or corrected visual acuity reading of the patient's eye at a distance (e.g. about 4 m) or nearby (e.g. about 40 cm) or at the patient's preferred distance, relevant scan images of a patient's eye, or other similar images. Although not illustrated, other fields are contemplated by the scope of this description—e.g., fields asking for other side effects of the procedure, other changes in the health of the patient, or changes in the medical or vision insurance data of the patient. Additionally, in some embodiments, the post-op tab 420C may instead be displayed by the client-side software application at the client computing system (e.g., 205A, 205B, or 205C of FIG. 2), after which the post-op data may be sent through the network 210 to the server computing system 215 and stored at the clinical evaluation software 220.

In one embodiment, the post-op tab 420C tracks several sets of data for the patient. In the illustrated embodiment, the post-op tab 420C includes six (6) data sets for monitoring the patient after the lens implantation (e.g., one day, one week, one month, three months, six months, and 12 months). Fewer or a greater number of monitoring data sets are possible, at reporting intervals that may be different than those given here. These data sets are navigable within the clinical evaluation software user interface 330—e.g., via selectable input buttons, as illustrated. Thus, a user (e.g., a nurse or surgeon) may track the neural adaptation of the patient to the lens over time to ensure that the patient's visual acuity is expectedly improving.

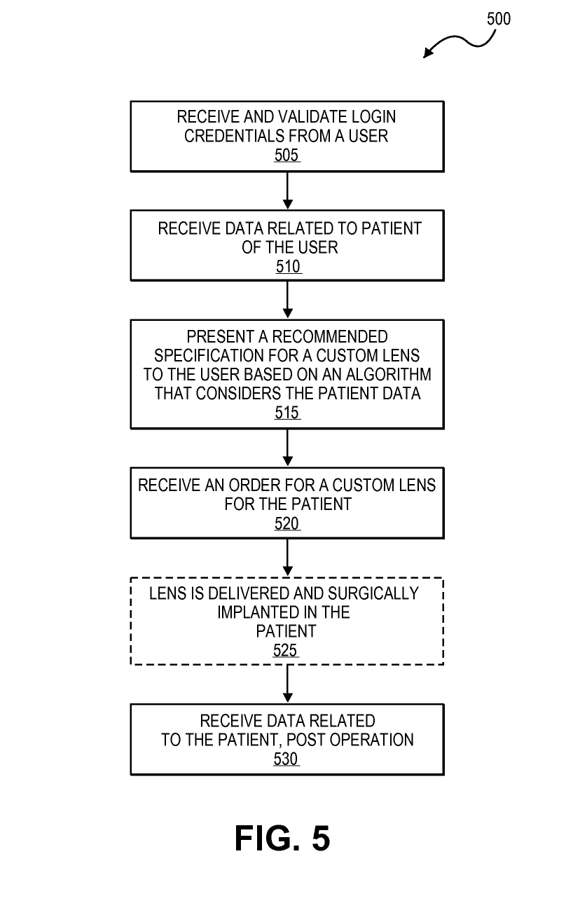

With reference to FIG. 5, a flow diagram illustrates a method 500 for ordering and post-operation monitoring of customized, surgically implanted intracorneal lens according to one embodiment of the invention. The method 500 can be performed by the server computing system 215 of FIG. 3 and/or the server computing system 215 communicatively coupled with the client computing systems 205A-C of FIG. 2. In some embodiments, the method 500 includes operations to be performed by a clinical evaluation service.

Beginning first with operation 505 of FIG. 5, login credentials are received from a user (e.g., a nurse or surgeon). Generally, these login credentials are received from a user of a remote system (e.g., a client computing system that is remote from the server computing system performing the method 500). These login credentials are then validated so that the data confidentiality may be maintained.

Once the user logs in with valid credentials, the data may be received from the user that is related to a patient, as shown at operation 510. Data related to the patient may broadly encompass a plurality of areas, such as a locale of the patient and/or the user, demographic information about the patient (e.g., ethnicity, age, gender, etc.), and more specific data about one or more visual problems that the patient suffers from (e.g., manifest refraction data). A user may also input images of the patient's eyes here so that topography, endothelial cell density, and/or OCT may be observed.

At operation 515, the user is presented with a recommended specification for a lens. The recommended specification for the lens is computed using an algorithm that considers at least a portion of the patient data received at operation 510. In one embodiment, this recommended specification is a power for a lens that adjusts the diopters for a visual axis and/or the anticipated positioning of the lens in the eye of the patient.

Proceeding to operation 520, an order for a lens for the patient is received from the user. Generally, this order is consistent with the recommended specification presented at operation 515. The order may be serviced using a remote manufacturing facility that produces lenses.

At operation 525, the ordered lens is delivered to the user and surgically implanted in the patient. In the illustrated embodiment, this operation 525 occurs outside the scope of the method 500 but must occur before proceeding to additional operations.

After the lens is implanted in the patient's cornea, data related to the patient (i.e., post-operation patient data) is received at operation 530. This post-operation data indicates how the patient is adjusting to the intracorneal implantation of the ordered lens. In some embodiments, the post-operation patient data received at operation 530 is similar to the pre-operation patient data received at operation 510. For example, data may be received that includes one or more measurements related to the manifest refraction of the patient's eyes, as well as images of the patient's eyes related to topography, endothelial cell density, OCT, visual acuity at distance (e.g., at about 4 m) and near (e.g., at about 40 cm), uncorrected and corrected, slit lamp assessment, in addition to uncorrected near visual acuity at the distance preferred by the patient), relevant scan images of a patient's eye, or other similar images. In some embodiments, data may also be received that indicates the patient's subjective experience with the lens (e.g., the user may input data indicating that the patient is satisfied with the lens).

In one embodiment, operation 530 may be revisited one or more times for the patient. For example, data may be received from the user for that patient one month after the lens implantation, six months after implantation, and twelve months after implantation. Thus, a user (e.g., a nurse or surgeon) may track the neural adaptation of the patient to the lens to ensure that the patient's visual acuity is expectedly improving.

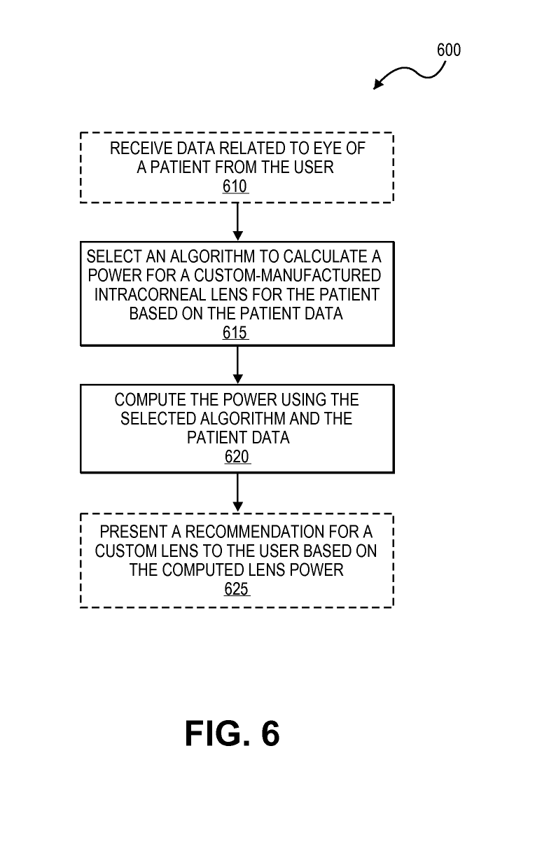

Turning now to FIG. 6, a method 600 is shown illustrating a method for customizing an intracorneal lens that is to be surgically implanted according to one embodiment of the invention. In one embodiment, the operations of the method 600 occur between operations 510 and 515 of the method 500 of FIG. 5. Therefore in the illustrated embodiment, operations 610 and 625 are analogous to operations 510 and 515, respectively.

First with reference to operation 615, an algorithm is selected to calculate a power for a lens for the patient. In one embodiment, the algorithm is selected from amongst several algorithms that can be used to derive a power for a lens. Because the ocular structure of individuals varies, the algorithm may be selected according to some or all of the patient data received at operation 610. For example, different algorithms may be necessary for different geographical locales or different demographics. Accordingly, a user may enter a specific locale or ethnicity for the patient, and a corresponding algorithm for that specific locale or ethnicity is then automatically selected (by the clinical evaluation software 220.)

With a suitable algorithm selected, the method 600 proceeds to operation 620. Here, the selected algorithm is used to compute a power for the lens. Generally, this computation considers patient data received at operation 610; however, this may be different patient data than that used to select the algorithm at operation 615. For example, a manifest refraction spherical equivalent of the patient may be accounted for in the computation of the power for the lens at operation 615, but not considered in the selection of the algorithm at operation 615.

At operation 625, the computed power for the lens is returned (e.g., as the result of a computational method or function) and then formatted so that it may be presented to the user (e.g., as part of the recommended specification).

In the description above, for the purposes of explanation, numerous specific details have been set forth in order to provide a thorough understanding of the embodiments of the invention. It will be apparent however, to one skilled in the art, that one or more other embodiments may be practiced without some of these specific details. The particular embodiments described are not provided to limit the invention but to illustrate it. The scope of the invention is not to be determined by the specific examples provided above but only by the claims below. In other instances, well-known structures, devices, and operations have been shown in block diagram form or without detail in order to avoid obscuring the understanding of the description. Where considered appropriate, reference numerals or terminal portions of reference numerals have been repeated among the figures to indicate corresponding or analogous elements, which may optionally have similar characteristics.

Various operations and methods have been described. Some of the methods have been described in a basic form in the flow diagrams, but operations may optionally be added to and/or removed from the methods. In addition, while the flow diagrams show a particular order of the operations according to example embodiments, it is to be understood that that particular order is exemplary. Alternate embodiments may optionally perform the operations in different order, combine certain operations, overlap certain operations, etc. Many modifications and adaptations may be made to the methods and are contemplated.

It should also be appreciated that reference throughout this specification to “one embodiment,” “an embodiment,” or “one or more embodiments,” for example, means that a particular feature may be included in the practice of the invention. Similarly, it should be appreciated that in the description various features are sometimes grouped together in a single embodiment, Figure, or description thereof for the purpose of streamlining the disclosure and aiding in the understanding of various inventive aspects. This method of disclosure, however, is not to be interpreted as reflecting an intention that the invention requires more features than are expressly recited in each claim. Rather, as the following claims reflect, inventive aspects may lie in less than all features of a single disclosed embodiment. Thus, the claims following the Detailed Description are hereby expressly incorporated into this Detailed Description, with each claim standing on its own as a separate embodiment of the invention.

What is claimed is:

1. A method executed by a computing system for ordering customized intracorneal lenses that are to be surgically implanted, comprising:
receiving a first refraction data through a first refraction data field of a user interface of the system, the first refraction data related to an eye of a patient into which a lens is to be implanted;
computing a recommended specification for the lens based on an algorithm that uses the first refraction data;
displaying the computed lens specification through the user interface; and
receiving an order for the lens from the user interface, the order being consistent with the recommended specification.

2. The method of claim 1, further comprising:
fulfilling and delivering the lens identified by the order.

3. The method of claim 1, further comprising:
receiving a second refraction data through a second refraction data field of the user interface after the ordered lens has been implanted in the a cornea of the patient's eye, the second data related to the eye of the patient into which the ordered lens was implanted, and receiving an adaptation data through an adaptation data field of the user interface, the adaptation data indicating how the patient is adjusting or neurally adapting to an intracorneal implantation of the ordered lens.

4. The method of claim 3, further comprising:
receiving further refraction data through the second refraction data field of the user interface a plurality of times during the first year after the ordered lens was implanted in the cornea of the patient.

5. The method of claim 3, wherein the second refraction data includes imaging data, the imaging data comprising images of the patient's eyes that provide information related to eye topography or endothelial cell density, or that are obtained using optical coherence tomography (OCT).

6. The method of claim 1, wherein the first refraction data field is displayed within a first tabbed section of the user interface, and wherein the recommended specification is displayed within a second tabbed section of the user interface, and wherein the second refraction data field and the adaptation data field are displayed within a third tabbed section of the user interface.

7. The method of claim 1, further comprising:
selecting the algorithm for computing the recommended lens specification based on the first data, the algorithm selected from a plurality of stored algorithms.

8. The method of claim 1, further comprising:
selecting the algorithm for computing the recommended lens specification based on a geographic location of the patient or a demographic that the patient belongs to, the algorithm selected from a plurality of stored algorithms.

9. The method of claim 1 further comprising:
receiving and authenticating login credentials from the user interface prior to the method of claim 1; and
without requiring a re-entry or a re-authorization of login credentials, repeating the method of claim 1 for a second patient and receiving a second data related to a third patient, the second data indicating how the third patient is adjusting or neurally adapting to an intracorneal implantation of a previously ordered lens.

10. The method of claim 1, wherein the computing of the recommended specification for the lens based on the algorithm that considers the first data comprises:
subtracting 0.25 diopters from a manifest refraction spherical equivalent measured for the eye of the patient.

11. The method of claim 1, further comprising:
checking if the patient is an acceptable candidate for lens implantation; and presenting an alert if the patient is not an acceptable candidate for lens implantation.

12. A clinical evaluation system for ordering customized intracorneal lenses that are to be surgically implanted, the system including a server computer, the system comprising:
a server computer memory within the server computer;
a server computer network interface within the server computer; and
a server computer processor within the server computer, the server computer processor coupled to the server computer memory and the server computer network interface;
a software user interface executed by one of (a) the server computer processor or (b) a client computer processor within a client computer that is capable of communicating with the server computer network interface, the user interface comprising a first tabbed section that is operable to display a first refraction data field, the first refraction data field operable to receive a first refraction data related to an eye of a patient into which a lens is to be implanted, the user interface also comprising a second tabbed section that is operable to display a recommended specification for the lens, the recommended specification for the lens being computed by one of (a) the server computer processor or (b) the client computer processor based on an algorithm that uses the first refraction data, the second tabbed section further operable to receive an order for the lens, where the order is consistent with the recommended specification for the lens.

13. The system of claim 12, wherein the second tabbed section is further operable to initiate any one of (a) fulfillment, (b) delivery, or (c) eye surgery of the lens identified by the order.

14. The system of claim 12, wherein the user interface also comprises a login section operable to receive and authenticate login credentials.

15. The system of claim 12, wherein the user interface also comprises a third tabbed section that is operable to display a second refraction data field that is operable to receive a second refraction data related to the eye of the patient into which the ordered lens was implanted, the third tabbed section also operable to display an adaptation refraction data field that is operable to receive an adaptation refraction data related to the how the patient is adjusting or neurally adapting to an intracorneal implantation of the ordered lens.

16. The system of claim 15, wherein the second refraction data field is operable to receive imaging data, the imaging data comprising images of the patient's eyes that provide information related to eye topography or endothelial cell density, or that are obtained using optical coherence tomography (OCT).

17. The system of claim 12, wherein, prior to displaying the recommended specification in the second tabbed section, one of (a) the server computer processor or (b) the client computer processor is operable to select an algorithm, the algorithm being for computing the recommended lens specification, wherein the selection is based on the first data, the algorithm being selected from a plurality of stored algorithms.

18. The system of claim 12, wherein, prior to displaying the recommended specification in the second tabbed section, one of (a) the server computer processor or (b) the client computer processor is operable to select an algorithm, the algorithm being for computing the recommended lens specification based on a geographic location indication or a demographic indication that was previously received by the user interface, the algorithm being selected from a plurality of stored algorithms.

19. The system of claim 12, wherein, prior to displaying the recommended specification in the second tabbed section, one of (a) the server computer processor or (b) the client computer processor is operable to compute the recommended specification for the lens, the recommended specification for the lens computed by subtracting 0.25 diopters from a manifest refraction spherical equivalent measured for the eye of the patient.

20. The system of claim 12, wherein the user interface is operable to present an alert if the first refraction data field receives first refraction data indicating that the patient is not an acceptable candidate for lens implantation.
